(19) United States
(12) Patent Application Publication
(10) Pub. No.: US 2010/0122732 A1
(43) Pub. Date: May 20, 2010

(54) Method for Rejuvenating the Ozone Layer

(76) Inventor: Baruch Dagan, Vero Beach, FL (US)

Correspondence Address: HAYWORTH, CHANEY & THOMAS, P.A., 202 N. HARBOR CITY BLVD., SUITE 300, MELBOURNE, FL, 32935, US

(21) Appl. No.: 12/619,801

(22) Filed: Nov. 17, 2009

Related U.S. Application Data
(60) Provisional application No. 61/115,751, filed on Nov. 18, 2008.
(60) Provisional application No. 61/115,783, filed on Nov. 18, 2008.

(51) Int. Cl. G05D 11/08

(52) U.S. Cl. 137/3

(57) ABSTRACT

A method for utilizing an aircraft to transport a container of beneficial gas to altitudes greater than five kilometers and releasing the beneficial gas into the stratosphere at that altitude. The released beneficial gas may comprise oxygen, neutralizing chemicals in gas form, other gases beneficial to the ozone layer, or the like. The aircraft transporting the container of beneficial gas may comprise an airplane, a balloon, or any other aircraft known in the art. Additionally, the beneficial gas may be released at altitudes greater than five kilometers, such as seven or ten kilometers. A threshold ozone concentration level may be determined such that beneficial gas is released from the containers only when the measured ozone concentration is below the threshold ozone concentration level. Further, the stratospheric density may be measured and the quantity of beneficial gas released into the stratosphere may be determined in proportion to the measured stratospheric density.

### CROSS REFERENCE TO RELATED APPLICATIONS

This application claims the benefit of provisional patent applications Ser. Nos. 61/115,751 and 61/115,783, filed with the USPTO on Nov. 18, 2008, which are herein incorporated by reference in their entirety.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISK

Not applicable.

### BACKGROUND OF THE INVENTION

1. Field of the Invention

The present invention generally relates to methods and an apparatus for restoring ozone in the stratosphere, more specifically, the present invention relates to a method for providing beneficial gas to the stratosphere. The beneficial gas may be provided by aircraft or an ozone rejuvenation apparatus.

2. Background Art

The ozone layer in the stratosphere is created by powerful ultraviolet (UV) rays colliding with oxygen molecules, O₂. The UV rays break down the molecule into two atoms of oxygen, O+O. These atoms may rejoin along with another atom of oxygen and create a new molecule, O₃, which is ozone and comprises the ozone layer. The ozone molecule is very unstable and reacts with many chemicals which may destroy the molecule. Throughout the years during the industrial revolution, many man-made chemicals and some natural chemicals were released into the stratosphere and have found their way to the stratosphere. Those chemicals reacted with the ozone and destroyed ozone. Some of the chemicals, such as chlorofluorocarbons (CFC's), which made their way to the stratosphere, reacted with the UV rays and turned into chlorine. Chlorine is harmful for the ozone and can persist in the ozone layer for up to twenty years. A large depletion of ozone layer has been observed, much of this depletion is in the Polar Regions with the worst depletion affecting the Antarctic stratosphere.

The stratosphere begins at about 17 km high near the equator and as low as 7 km high near the poles. The arctic pole and most of Antarctica are in total darkness in the winter for approximately six months. There are no UV rays during those months and ozone is not produced at that time in the Polar Regions. The ozone from higher elevations slides down slowly towards the Polar Regions and maintains the thickness of the ozone layer even though there is no production of ozone during the winter. During the winter, a mist of chemicals and contaminants builds up in the stratosphere in the Polar Regions. Icy clouds in the polar region prevent oxygen from traveling up to the stratosphere. This mist is called the arctic haze and it is made from aerosols.

The dark winter time in Antarctica ends as the spring arrives in September. As spring arrives, the reproduction of ozone begins. However, the CFC's, chlorine gases, bromide and carbons which are mixed in the air in the low stratosphere may destroy newly created ozone. If the amount of oxygen in the polar stratosphere, particularly the Antarctic stratosphere, could be increased and the contaminants in the air which destroy ozone could be decreased, a thick layer of ozone could be produced in the Polar Regions and elsewhere as needed.

Increasing the amount of ozone in the stratosphere may have many beneficial effects. Fewer harmful UV rays may penetrate the ozone layer and reach the Earth's surface because the ozone layer filters out UV rays. Reducing the amount of UV rays that reach the Earth's surface may also prevent or slow the melting of polar glaciers. Reducing polar glacier melting is important because sixty-four percent (64%) of the Earth's drinking water is stored in those glaciers. Preventing polar glacier melting may also prevent the rising of ocean levels and erosion of beaches. When the polar glacier ice melts into the oceans, the salinity of the ocean is decreased which results in changes to the marine life and vegetation habitat. Additionally, increasing ozone may slow or reverse global warming, which may be responsible for stronger winds and storms such as typhoons, hurricanes and tornados. Creating additional ozone may also help forests and vegetation on our planet to grow healthier because they may be exposed to less UV radiation. The improved health of forests and other vegetation may provide a better photosynthesis process, creating a better quality of air and a higher percentage of oxygen in the air. Filtering out UV radiation may also result in a lower rate of skin cancer, less lung dysfunction, and many other benefits to our planet.

To achieve these goals and other benefits, more oxygen and neutralizing chemicals must be provided to the stratosphere. It may be desirable to begin providing these substances at the Polar Regions, particularly, the Antarctic zone, because this is where the hole in the ozone is most severe. Later, it may be desirable to provide these substances to other areas around our planet as necessary to improve the health of the ozone layer, or cool off hot zones, such as, for example, deserts.

### BRIEF SUMMARY OF THE INVENTION

The present invention is directed to the idea and methods of and an apparatus for providing air, air enriched with oxygen, pure oxygen, or neutralizing chemicals in gas form, such as, for example, hydrogen, to the stratosphere. These gases can be released into the stratosphere to provide the building blocks of raw material for the creation of new ozone or to prevent further depletion of existing ozone. In either case, the release of these gases into the stratosphere may improve the quality of the Earth's protective ozone layer.

One embodiment of the invention may utilize an ozone rejuvenation apparatus for providing air, air enriched with oxygen, pure oxygen, or neutralizing chemicals in gas form to the stratosphere. An ozone rejuvenation apparatus may comprise combinations of three machines with speed controls and flow controls that makes the air spin upwards. These three machines are a high volume blower, a speed booster and spinner, and a tornado rotator. The volume, pressure, turbulence, and speed of the gas may be controlled by these machines to create a helix type turbulence. This turbulence may help the output of the ozone rejuvenation apparatus overcome gravity and penetrate into the stratosphere. The output of the ozone rejuvenation apparatus may carry air, air enriched with oxygen, pure oxygen, or neutralizing chemicals in gas form to the stratosphere.

Another embodiment of the present invention may deliver air, air enriched with oxygen, pure oxygen, or neutralizing chemicals in gas form to the stratosphere by utilizing an aircraft. The air, air enriched with oxygen, pure oxygen, or neutralizing chemicals in gas form may be loaded onto an aircraft. When the aircraft reaches the desired altitude, the air, air enriched with oxygen, pure oxygen, or neutralizing chemicals in gas form may be released to the stratosphere. The air, air enriched with oxygen, pure oxygen, or neutralizing chemicals in gas form may then react with environmental elements, such as, for example, ultraviolet light, other chemicals present in the air, or other elements to produce new ozone or prevent the further destruction of existing ozone.

The aircraft delivering the air, air enriched with oxygen, pure oxygen, or neutralizing chemicals in gas form to the stratosphere may be equipped with an instrument to measure the ozone concentration in the stratosphere. The ozone concentration in the stratosphere may be measured and the air, air enriched with oxygen, pure oxygen, or neutralizing chemicals in gas form may be released into the stratosphere only when the measured ozone concentration is below the threshold ozone concentration level. The threshold ozone concentration level may be selected such that air, air enriched with oxygen, pure oxygen, or neutralizing chemicals in gas form are released only in areas of the stratosphere which have less than an average ozone concentration. Alternatively, the threshold ozone concentration level may be selected such that air, air enriched with oxygen, pure oxygen, or neutralizing chemicals in gas form are released only in areas of the stratosphere which have a critically low measured ozone concentration or in areas of the stratosphere which have merely a less than optimal ozone concentration. Additionally, air, air enriched with oxygen, pure oxygen, or neutralizing chemicals in gas form may be released without respect to the measured ozone concentration or may be released to increase the measured ozone concentration even though the measured ozone concentration may already be at an acceptable level.

The aircraft delivering the air, air enriched with oxygen, pure oxygen, or neutralizing chemicals in gas form to the stratosphere may be equipped with an instrument to measure the air density in the stratosphere. Stratospheric density may be measured and the air, air enriched with oxygen, pure oxygen, or neutralizing chemicals in gas form may be released in proportion to the measured stratospheric density. Because the concentration of oxygen and other elements tends to decrease with decreasing stratospheric density, releasing air, air enriched with oxygen, pure oxygen, or neutralizing chemicals in gas form in proportion to the measured stratospheric density may allow air, air enriched with oxygen, pure oxygen, or neutralizing chemicals in gas form to be released in such a way that only as much air, air enriched with oxygen, pure oxygen, or neutralizing chemicals in gas form as is necessary for the particular stratospheric conditions is released. Smaller quantities of air, air enriched with oxygen, pure oxygen, or neutralizing chemicals in gas form may be released in areas of high ozone concentration than may be released in areas of low ozone concentration.

Delivering gas to the stratosphere may be particularly beneficial in the Polar Regions. This may be because the amount of ozone in the stratosphere in these regions is depleted more than in other regions of the stratosphere. Additionally, harmful chemicals, such as, for example, chlorine, may collect in the Polar Regions. Providing air, air enriched with oxygen, pure oxygen, or neutralizing chemicals in gas form to the stratosphere above the Polar Regions may aid in increasing the total amount of ozone in those areas and may also aid in preventing further depletion of existing ozone.

However, the Polar Regions may not be the only geographic regions which may benefit from releasing air, air enriched with oxygen, pure oxygen, or neutralizing chemicals in gas form. Other areas on Earth which have non-optimal ozone levels in the stratosphere may also benefit from releasing air, air enriched with oxygen, pure oxygen, or neutralizing chemicals in gas form to the stratosphere. Areas on Earth which have significant ultra-violet light exposure, such as, for example, tropical regions, may benefit from an increase in the ozone concentration in the stratosphere above the region. This may be because ozone helps filter out ultra-violet light and the increased ozone in the stratosphere may protect people or animals in these areas from the harmful effects of ultra-violet light and may cool off the Earth.

### BRIEF DESCRIPTION OF THE DRAWINGS

A better understanding of the present invention will be realized from the detailed description that follows, taken in conjunction with the accompanying drawings, in which:

FIG. 1 depicts one embodiment of an ozone rejuvenation apparatus.

FIG. 2 depicts one embodiment of a high pressure/high volume blower.

FIG. 3 depicts one embodiment of an oxygen feed valve segment.

FIG. 4 depicts one embodiment of a speed booster and spinner.

FIG. 5 depicts one embodiment of a tornado rotator.

FIG. 6 depicts one embodiment of a silencer.

FIG. 7 depicts one embodiment of a method for rejuvenating the ozone layer.

FIG. 8 depicts another embodiment of a method for rejuvenating the ozone layer.

FIG. 9 depicts yet another embodiment of a method for rejuvenating the ozone layer.

### DETAILED DESCRIPTION OF THE INVENTION

Although the following detailed description contains many specifics for the purposes of illustration, anyone of ordinary skill in the art will appreciate that many variations and alterations to the following details are within the scope of the invention. Accordingly, the following preferred embodiments of the invention are set forth without any loss of generality to, and without imposing limitations upon, the claimed invention.

The inventive method may comprise providing beneficial gas, such as, for example, oxygen, which may be pure oxygen, oxygen enriched air, or oxygen in combination with any other gas or gases; neutralizing chemicals in gas form, such as, for example, hydrogen; other gases beneficial to the ozone layer; or the like to the stratosphere at altitudes which are sufficiently high to allow existing environmental forces to react with the beneficial gas and allow creation of new ozone or neutralize harmful chemicals to prevent the further destruction of ozone. Newly created ozone may be added to the ozone layer of the Earth's stratosphere. Additionally, the inventive method may comprise providing beneficial gas to the stratosphere at altitudes at which the beneficial gas may counteract the negative effects of harmful substances present in the stratosphere. The inventive concept may include any method of delivering or providing beneficial gas to the stratosphere.

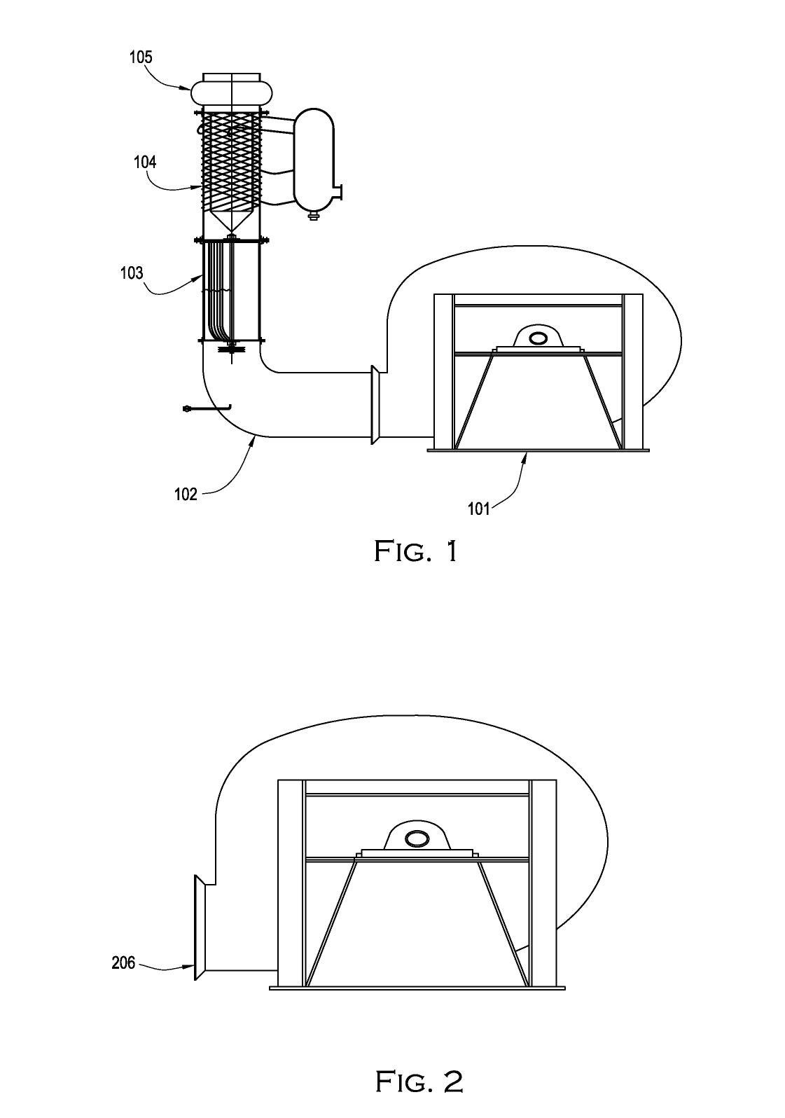

One embodiment of the inventive concept may utilize an ozone rejuvenation apparatus as depicted in FIG. 1 to bring beneficial gas to the stratosphere. Such an ozone rejuvenation apparatus may be constructed from five different components, the high pressure/high volume blower 101, the oxygen feed valve 102, the speed booster and spinner 103, the tornado rotator 104, and the silencer 105. Each stage of the apparatus may increase the speed and velocity of the beneficial gas flow and rotate the outcome of the machine to very high speed circulation. This process may enable the output of the ozone rejuvenation apparatus to overcome the gravity and the friction of the surrounding air and rise upwards to the stratosphere, where the output of the ozone rejuvenation apparatus may be utilized by environmental factors to create ozone or neutralize chlorine or other contaminants.

Another embodiment of the ozone rejuvenation apparatus may comprise combinations of three machines with speed controls and flow controls that makes the air spin, resembling a twister of a tornado, upwards. These three machines are a high pressure/high volume blower 101, a speed booster and spinner 103 and a tornado rotator 104. The volume of air, the pressure of the air, the turbulence and speed may be controlled by these machines to create a helix type turbulence. This turbulence may help the output of the ozone rejuvenation apparatus overcome gravity and penetrate into the stratosphere.

The output of the ozone rejuvenation apparatus may carry beneficial gas to the stratosphere, which includes air space located between 7 km and 50 km. When the output of the ozone rejuvenation apparatus rises to the level of the stratosphere, it may enable delivery of beneficial gas which may react with the chlorine and other contaminants in the stratosphere and disable their destructive capabilities toward the ozone.

The ozone rejuvenation apparatus may be mounted on an ordinary ship or an ice breaker ship. Such a mounting may be a preferred embodiment to enable the ozone rejuvenation apparatus to be operated in the arctic area.

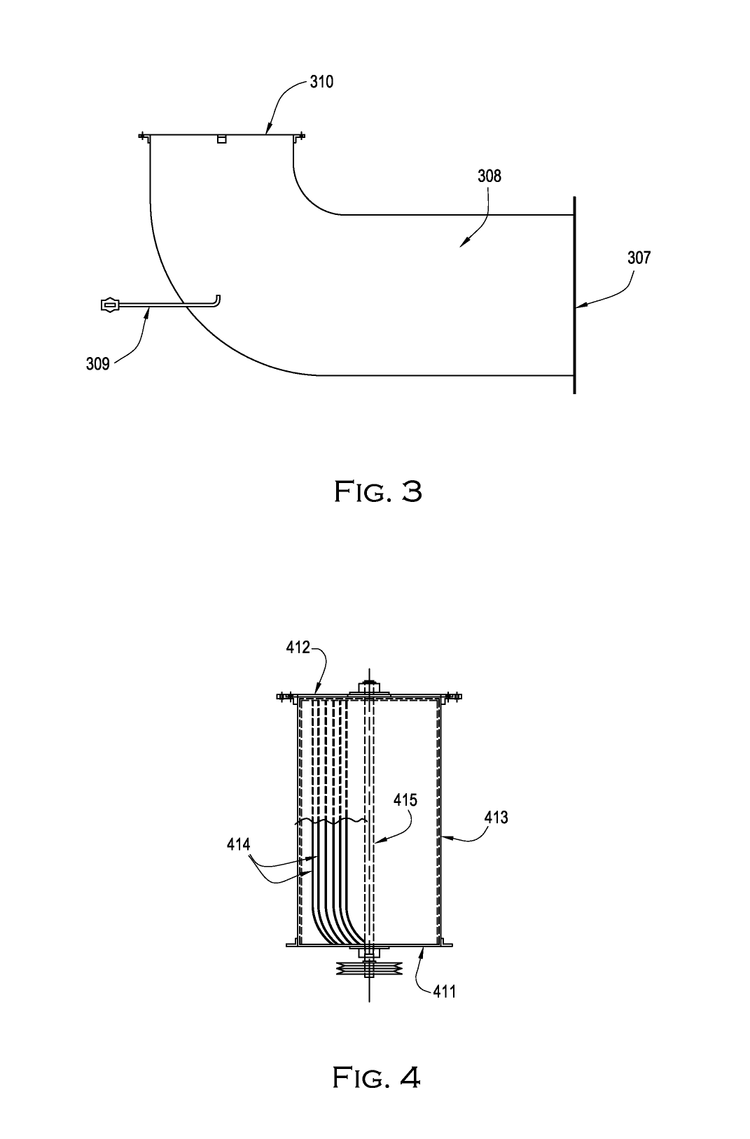

The ozone rejuvenation apparatus comprise a high pressure/high volume blower 101. FIG. 2 depicts an enlarged view of a possible embodiment of the high pressure/high volume blower 101. A preferred embodiment of the blower may comprise a rectangular discharge port 206, measuring 30.25″ by 18.5″ with an area of 559.63 sq. in., a fifty horse-power motor providing 4,000 cubic feet per minute (CFM) air output, 3,450 rotations per minute (rpm), operated by 480 volts AC with a variable-frequency drive (VFD) control. The high pressure/high volume blower 101 may be connected to any power supply, such as, for example, output from a renewable energy supply, such as, for example, solar cells, wind turbines, or the like, a generator, conventional AC outlet, truck loaded generator, nuclear power station, or the like. The high pressure/high volume blower 101 may intake ambient air and output air at a rate measured in CFM. The air may be output by the high pressure/high volume blower 101 through the discharge port 206. Higher output rates of air may be preferred, and a preferred embodiment of the ozone rejuvenation apparatus may comprise a high pressure/high volume blower 101 which may output at least 4,000 CFM.

The discharge port 206 of the high pressure/high volume blower 101 may be connected to the second part of the ozone rejuvenation apparatus, comprising an oxygen feed valve segment 102. One possible embodiment of the oxygen feed valve segment 102 is depicted in FIG. 3. The first end 307 of the oxygen feed valve segment 102 may be connected directly to the discharge port 206 of the high pressure/high volume blower 101 such that all air output by the high pressure/high volume blower 101 may be directed into the first end 307 of the oxygen feed valve segment 102. The oxygen feed valve segment 102 may comprise a connecting elbow 308 and a valve 309. The connecting elbow 308 may be a hollow structure with a first end 307 and a second end 310. The first end 307 may be connected to the discharge port 206 of the high pressure/high volume blower 101. The valve 309 may be connected to the connecting elbow 308 such that the valve 309 may be used to inject gas external to the oxygen feed valve segment 102 into the oxygen feed valve segment 102. The port of the valve 309 external to the system may be connected to oxygen or any other gas which may then be injected into the system by use of the valve 309. Injecting gas into the system by use of the valve 309 may result in gas being deposited into the connecting elbow 308 and commingling with the output of the high pressure/high volume blower 101. In embodiments in which oxygen is injected into the system by using the valve 308, the air exiting the oxygen feed valve segment 102 through the second end 310 may be air that is enriched with a higher concentration of oxygen than normally occurs in the environment.

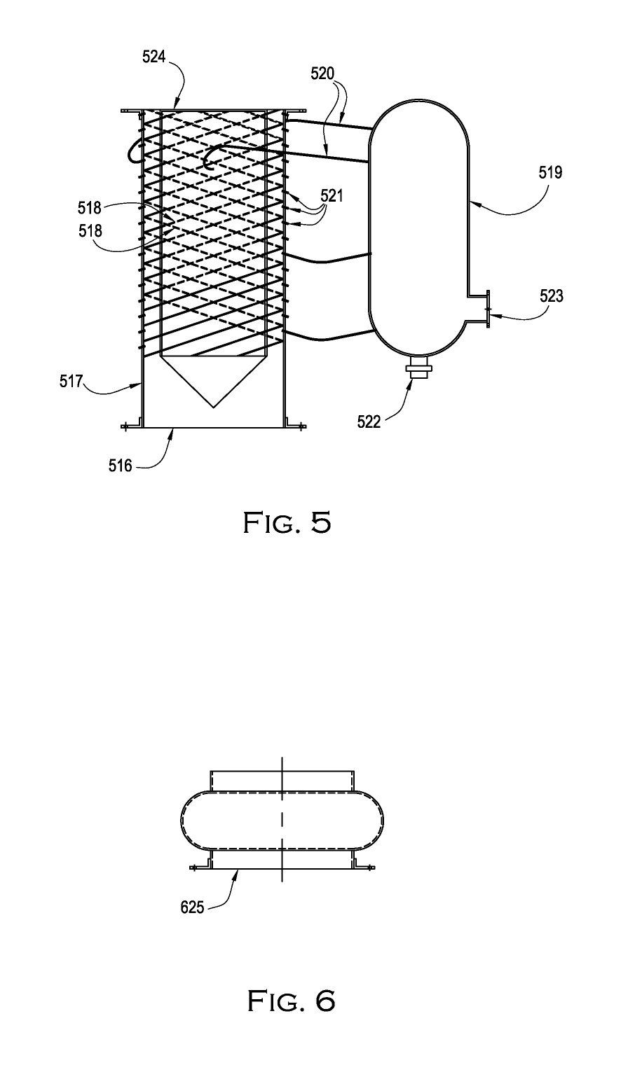

One possible embodiment of the speed booster and spinner 103 is depicted in FIG. 4. The second end 310 of the connecting elbow 308 of the oxygen feed valve segment 102 may be connected to the intake port 411 of a speed booster and spinner 103. The speed booster and spinner 103 may accelerate the air provided through the second end 310 of the oxygen feed valve segment 102. The speed booster and spinner 103 may be controlled by an external motor. A preferred embodiment of the external motor may be a 50 horse-power motor at 480 volts AC, rotating at 3,450 rpm and controlled by a VFD. The speed booster and spinner 103 may comprise a hollow segment 413 with a plurality of rotatable blades 414 disposed within the hollow segment 413. The plurality of rotatable blades 414 may rotate at ten thousand (10,000) rpm by using pulleys with a ratio of 1:3. The plurality of rotatable blades 414 may be connected to a drive shaft 415 which is disposed within the hollow segment 413 and is located in the center of the hollow segment 413 in a plane traveling from the intake port 411 of the hollow segment 413 to the output port 412 of the hollow segment 413 and essentially equidistant from all sides of the hollow segment 413, in embodiments in which the hollow segment 413 is essentially cylindrical. In embodiments in which the hollow segment 413 is not essentially cylindrical, the drive shaft 415 may be located in a plane traveling from the intake port 411 of the hollow segment 413 to the output port 412 of the hollow segment 413 and located far enough from all sides of the hollow segment 413 such that the plurality of rotatable blades 414 may not contact any side of the hollow segment 413 as the drive shaft 415 rotates and the plurality of rotatable blades 414 travel around the interior of the hollow segment 413. The plurality of rotatable blades 414 may be connected to the drive shaft 415 near the intake port 411. The plurality of rotatable blades 414 may extend parallel to one another through the hollow segment 413 of the speed booster and spinner 103 to the output port 412. The external motor may be connected to and power the drive shaft 415 which, in turn, rotates the plurality of rotatable blades 414. The air exiting the speed booster and spinner 103 through the output port 412 may have a higher velocity than the air entering the speed booster and spinner 103 through the intake port 411. The operation of the speed booster and spinner 103 may determine the speed of the turbulence of the air exiting the speed booster and spinner 103 through the output port 412.

One possible embodiment of the tornado rotator is depicted in FIG. 5. The output port 412 of the speed booster and spinner 103 may be connected to the input port 516 of the tornado rotator 104. The tornado rotator 104 may comprise a hollow segment 517 with a plurality of helical blades 518 disposed inside the hollow segment 517. The plurality of helical blades 518 may spiral upwards in a counterclockwise manner. Additionally, the plurality of helical blades 518 may spiral upwards in a clockwise manner. In a preferred embodiment, the hollow segment 517 of the tornado rotator 104 may be essentially cylindrical. In such embodiments, the plurality of helical blades 518 may form a circular helix. In a preferred embodiment, the plurality of helical blades 518 may be angled at 22.5 degrees and spiral upwards in a clockwise direction.

Additionally, the tornado rotator 104 may comprise an air tank 519 connected to an air compressor, a plurality of tubes 520 connecting the air tank 519 to the hollow segment 517, and a plurality of connection points 521 on the hollow segment 517, to which the plurality of tubes 520 may be attached. The air compressor may maintain the air tank 519 with pressurized air. This pressurized air may be released into the hollow segment 517 through the plurality of tubes 520.

In a preferred embodiment, there may be 64 tubes with ¼ inch inner diameter. In a preferred embodiment, there may be 64 connection points with a diameter of 1/16 inch. In a preferred embodiment, these connection points may be located in the perimeter of the hollow segment 517 in four parallel lines of 16 connection points each, each line of connection points may be placed equidistant from the line of connection points on either side of a given line of connection points, such that from the perspective of the center of the hollow segment, there are four lines of 16 connection points located around the perimeter of the hollow segment and each line of 16 connection points is located 90 degrees from the two adjacent lines of 16 connection points. In a preferred embodiment, there may be 16 turns of the helical blades within the tornado rotator 104. In a preferred embodiment, each connection point may be oriented in the wall of the hollow segment 517 so that the output of the connection point may be parallel to the plane of the helical blades. The bottom portion of the air tank 519 may comprise a drain 522, from which liquid may be emptied from the air tank 519. The air tank 519 may also comprise an input port 523, to which a compressor may be attached. In a preferred embodiment, the air tank 519 may be connected to a compressor with a 5 inch diameter input port 523. In a preferred embodiment, the compressor may be capable of supplying air to the air tank 519 to create an air pressure of 125 pounds per square inch (psi), the compressor may be capable of outputting 2,200 cfm and may be operated with a 550 horse-power motor at 480 volts AC. A preferred embodiment of the discharge port of this compressor may comprise a five inch diameter pipe attached to the air tank 519 at the input port 523. The air supplied to the hollow segment 517 of the tornado rotator 104 through the plurality of tubes 520, may increase the velocity of the air and the speed of the rotation of the air, as well as increase the volume of air by an additional 2200 cubic feet per minute, as the air travels through the tornado rotator 104. The air exiting the tornado rotator 104 through the output port 524 may be rotating and traveling at increased velocity compared to the air entering the tornado rotator 104. The air which exits from the output port 524 of the hollow segment 517 of the tornado rotator 104 may be traveling at a higher velocity and rotating more rapidly than air in a naturally occurring tornado.

FIG. 6 depicts a possible embodiment of the silencer 105. The output port 524 of the hollow segment 517 of the tornado rotator 104 may be connected to the input port 625 of the silencer 105. The silencer 105 may allow the high velocity, rotating air generated by the ozone rejuvenation apparatus to escape from the ozone rejuvenation apparatus, while also dampening the noise produced by the ozone rejuvenation apparatus. The various internal configurations of the silencer 105 may be similar to structures used to suppress the sound of a discharged firearm and are well known to those skilled in the art.

The ozone rejuvenation apparatus may output a column of air moving at high velocity and rotating in a helical column. This high velocity motion and rotation allows the air to stay together and travel great distances with little dispersion into the ambient air. The helical rotation and velocity of the air allows the column of air to overcome gravity and frictional forces and to travel large distances of 10 km or more.

In use, the ozone rejuvenation apparatus may create columns of air with high velocity and helical rotation. These columns of air may be capable of traveling great distances. Beneficial gas may be carried in these helically rotating columns of air. In a preferred embodiment, the ozone rejuvenation apparatus may be used to provide oxygen enriched air to the stratosphere to enable the production of ozone.

The ozone rejuvenation apparatus may be accompanied by a plurality of trucks carrying a plurality of tanks. The plurality of tanks may contain a plurality of beneficial gas. The beneficial gas may be injected into the ozone rejuvenation apparatus through the valve 309 in the oxygen feed valve segment 102. The beneficial gas may be useful in neutralizing the chlorine in the stratosphere.

A plurality of ozone rejuvenation apparatuses may be utilized to treat the hole in the ozone in the arctic area. Other uses include, but are not limited to, utilizing the ozone rejuvenation apparatus in deserts and other hot climates to create a thicker layer of ozone which may filter the UV radiation and by doing so, may lower the ambient temperature, limit human exposure to UV radiation, and also provide other benefits which are well known to those skilled in the art.

The ozone rejuvenation apparatus may be capable of bringing beneficial gas to the stratosphere. The introduction of beneficial gas to the stratosphere may correct areas that are thin within the ozone layer and neutralize the negative effect of the chlorine gases that are harmful to the ozone in the stratosphere.

The ozone rejuvenation apparatus may comprise five different major components and each major component may increase the speed and the velocity of the beneficial gas and rotate the output of the machine. The resulting output of the ozone rejuvenation apparatus may be a large volume of beneficial gas that is rotating at high velocity. Because of the high velocity and rotation of the output beneficial gas, the ozone rejuvenation apparatus may overcome the power of gravity and friction between the ambient air and the ozone rejuvenation apparatus output, which may result in outputting rotating air that may climb 10 km or higher upwards.

Much of the damage to the ozone layer in the stratosphere is located around the South Pole or the North Pole. The height of the stratosphere in those Polar Regions may begin at 7 km.

The ozone rejuvenation apparatus may consume around 1,000 hp in electrical power. It may be desirable to install the ozone rejuvenation apparatus as closely as possible to a power station. A preferred power station may be a nuclear power station because this may prevent the creation of further pollution which may harm the ozone layer when the extra power needed to operate the machine is generated. In embodiments in which there is no power station in a close proximity, the ozone rejuvenation apparatus may be operated from an 18 wheeler truck which may be equipped with a boom. In addition to this truck, another truck carrying a diesel generator of 1,000 hp may be necessary, as well as one more truck which may carry oxygen, chemicals, or other gases.

In another embodiment, the entire infrastructure necessary to operate an ozone rejuvenation apparatus may be installed upon a ship or large barge. In embodiments in which the ozone rejuvenation apparatus may be utilized in the Polar Regions, a preferred embodiment may be to install the ozone rejuvenation apparatus on an icebreaker ship. Installation of the ozone rejuvenation apparatus on an icebreaker ship may enable the ozone rejuvenation apparatus to operate closer to the Poles.

The ozone rejuvenation apparatus may be utilized to create helically rotating high volume columns of air moving at high velocity. This air may be enriched with beneficial gas and may travel distances of 10 km or more due to the high velocity and helical rotation of the air. These columns of air may be used to provide oxygen enriched air to the stratosphere to enable the production of new ozone, or they may provide other chemicals to the stratosphere, which may neutralize chemicals which are harmful to the ozone layer.

Another embodiment of the inventive concept may comprise releasing or providing beneficial gas at high altitudes. In a preferred embodiment beneficial gas may be released or provided at altitudes above 5 km, 7 km, or 10 km. The air at high altitudes and in the stratosphere has the same relative percentages of nitrogen, oxygen, carbon dioxide and other molecules as on the earth's surface. However, in high altitudes and in the stratosphere, the density of air is lower than the density of air at the earth's surface because there is less atmospheric pressure on the air. Therefore, at higher altitude, there are fewer molecules of each of the composite materials comprising air when compared to the same volume of air at lower altitude. The density of oxygen at sea level (1 bar) is 1.429 grams per liter and the weight of one liter of air at the same pressure is 1.429 grams. At 10,000 feet of altitude (3,048 meters) the amount of atmospheric pressure decreases so that the volume of 1.429 grams of oxygen will increase by 29-30%, thereby decreasing the density of the oxygen correspondingly by approximately 29-30%. At an altitude of 10,000 feet (3,048 meters), the weight of one liter of oxygen is only 1.003 grams. This is because there are fewer oxygen molecules per liter at increased altitude.

It may be desirable to release or provide beneficial gas at an altitude of 10 km (30,480 feet) because this is a safe range to fly with a regular commercial aircraft. The density of the air at 10 km (30,480 feet) is about 9% of the density of the air at sea level and the oxygen in the air comprises about 20% of the volume of the air at both sea level and 10 km (30,480 feet); therefore, the total presence of oxygen at 10 km (30,480 feet) comprises about 1.8% of the total volume of air at that altitude if compared to the same volume at sea level. Each cubic meter of oxygen stored in canisters containing 100% oxygen and compressed under pressure of 122 bar (122 times atmospheric pressure) may provide 122 cubic meters of pure oxygen at one bar (1 atmosphere of pressure).

Because air at 10 km (30,480 feet) comprises only 1.8% oxygen, releasing a cubic meter of 100% oxygen stored at 122 bar, will introduce as much oxygen to the stratosphere as is found in 6777.7 cubic meters of air at that altitude under normal environmental conditions. Calculating based on the assumption that half of the oxygen normally found at 10 km (30,480 feet) has been destroyed, it may be determined that one cubic meter of pure oxygen compressed under pressure of 122 bar, may restore the level of oxygen in approximately 13,555.5 cubic meters of stratosphere to environmentally normal levels. This additional oxygen may allow the creation of necessary ozone which may be added to the ozone layer.

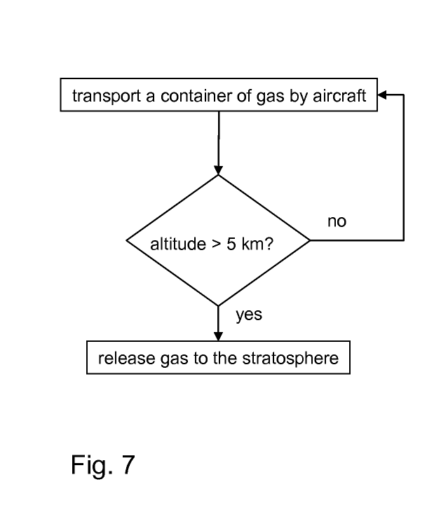

Another embodiment of the inventive concept may comprise a method utilizing an aircraft loaded with beneficial gas. Once in the stratosphere, the aircraft may release the beneficial gas into the ambient stratosphere. FIG. 7 depicts a possible embodiment in which the beneficial gas is released by an aircraft only when the aircraft is at an altitude above five kilometers (5 km). Although FIG. 7 depicts releasing beneficial gas only at altitudes above five kilometers (5 km), other altitudes may be determined to be more appropriate thresholds for releasing beneficial gas. This is, in part, because the stratosphere begins at different altitudes in different parts of the world. The appropriate altitude at which to release beneficial gas may be determined to be altitudes as high as seven kilometers (7 km), ten kilometers (10 km), or higher. The released beneficial gas may provide oxygen necessary to create new ozone which may be added to the ozone layer to fill in the existing holes in the ozone layer or may neutralize substances, such as, for example, chlorine or other harmful chemicals, which are present in the stratosphere and harmful to the ozone layer.

In some embodiments environmental factors, such as ultraviolet light, may work to react with oxygen released by the aircraft resulting in the formation of two distinct oxygen atoms. The oxygen atoms may then recombine along with a third oxygen atom to create ozone.

In some embodiments hydrogen molecules released from the aircraft may be broken down by ultraviolet light into two distinct hydrogen atoms. The hydrogen atoms may them recombine with oxygen atoms to form hydrogen peroxide (H₂O₂). The hydrogen peroxide may break down chlorine gas present in the stratosphere and neutralize the harmful effects of the chlorine gas on the ozone present in the stratosphere. The release of beneficial gas may be targeted specifically to areas in which the ozone layer is thin or in which there are pollutants.

In a preferred embodiment, any aircraft, such as, for example, a regular commercial airplane, a military airplane, any airplane, a balloon, or the like, may carry more than 200 cubic meters of pure compressed oxygen in aviation safe high altitude cylinders. This amount of pure compressed oxygen may double the production of ozone in an area 2,711,111.1 cubic meters large.

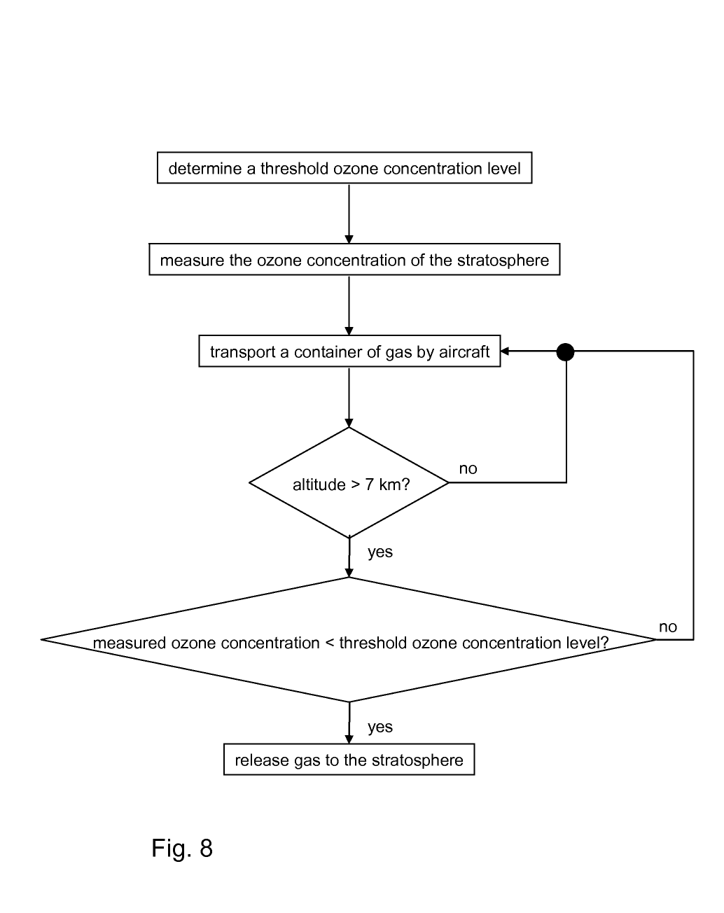

Each aircraft that may be used to supply beneficial gas may be equipped with one or more ozone sensors, which may be implemented by using a spectroscope, and one or more pressure gauges. FIG. 8 depicts a possible embodiment of the invention in which one or more ozone sensors may measure the actual ozone concentration of the stratosphere immediately surrounding the aircraft. A threshold ozone concentration level may be determined such that measured ozone concentrations below the threshold ozone concentration level warrant release of beneficial gas. As the aircraft flies through a low ozone concentration spot, that is an area with a measured ozone level less than or equal to the threshold ozone level, the aircraft may release beneficial gas.

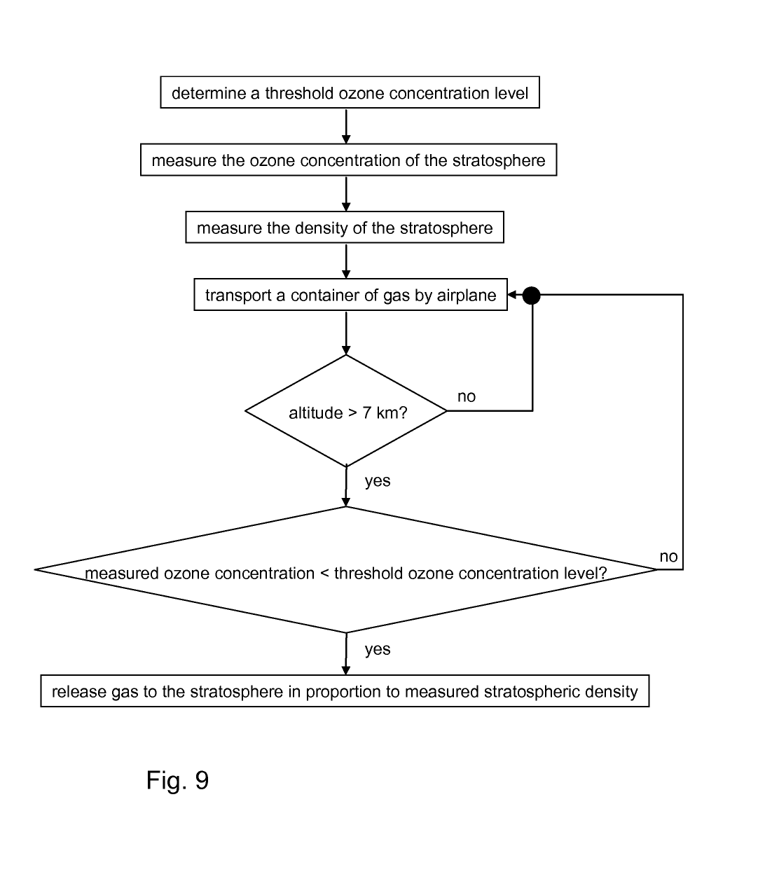

FIG. 9 depicts a possible embodiment in which a density gauge, such as, for example, a spectroscope, may be utilized to measure the stratospheric density immediately surrounding the aircraft. In such an embodiment, beneficial gas may be released in proportion to the measured stratospheric density. Beneficial gas may be released at a pressure slightly higher than the ambient air pressure at the altitude at which the plane is flying. At higher measured densities smaller amounts of beneficial gas may be released. This may ensure that adequate amounts of beneficial gas are released to effectively form ozone while also preventing excessive amounts of beneficial gas from being released in areas of high ozone concentration.

Aircraft utilized to supply pure beneficial gas may cruise for up to 10 hours or as limited by the mechanical capabilities of the aircraft, such as, for example, fuel capacity. These aircraft may fly within the Antarctic ozone hole and release beneficial gas as necessary at different altitude levels. Additionally, these aircraft may fly in different locations throughout the world to enrich ozone production or decrease ozone destruction by harmful substances.

It may be desirable to achieve a total of 150-180 flights during the spring and summer in the South and North Pole regions because ozone is produce during the spring and summer, when the sun is out. Achieving this number of flights may require one flight per day from September through February. After the oxygen is dispersed, the UV rays may break down the O₂ molecules into individual oxygen atoms. These oxygen atoms may then recombine to form ozone. This ozone may fill in the depleted hole in the existing ozone layer in the stratosphere.

Any aircraft may be used to disperse the oxygen into the stratosphere. However, the use of regular commercial airplanes, rather than ultrasonic airplanes may be preferred because, although ultrasonic airplanes may be capable of flying in higher altitudes, the use of regular commercial airplanes may reduce the amount of pollution emitted to the treated areas. Also, regular commercial airplanes may be more cost effective than ultrasonic airplanes.

Additionally, during the winter months, beneficial gas may be released into the polar vortex, which may be low in oxygen concentration and high in contaminant concentration. The polar vortex is a large-scale cyclone that is located near each of the Earth's poles. The polar vortex may prevent new oxygen from entering the stratosphere near the poles and may cause contaminants to get trapped and penetrate into the center of the vortex. The result of this polar vortex is a decrease in the level of ozone near the Earth's poles. By introducing beneficial gas into the polar vortexes, ozone may be produced in the poles from the moment the sun comes out in the Polar Regions. Another benefit of releasing beneficial gas in the polar vortexes is that chlorine gas and other contaminants may be neutralized during the winter season.

The inventive method comprises releasing beneficial gas to the stratosphere. In use, this may be accomplished by using an aircraft and releasing the beneficial gas directly into the stratosphere. However, the beneficial gas may reach the stratosphere by other methods.

Providing beneficial gas to the stratosphere may be particularly beneficial in the Polar Regions, where the ozone layer of the stratosphere may be thinnest. When utilized in the Polar Regions, the method may be most efficiently employed during the spring and summer. However, this method may be used in other regions on Earth and may be employed during any time of year to provide beneficial gas to the stratosphere.

Other uses of the inventive method include, but are not limited to, releasing beneficial gas in the stratosphere above deserts and tropical zones to create a thicker layer of ozone which may filter the UV radiation and by doing so, may lower the ambient temperature, limit human exposure to UV radiation, and also provide other benefits which are well known to those skilled in the art.

While the above description contains much specificity, these should not be construed as limitations on the scope of any embodiment, but as exemplifications of the presently preferred embodiments thereof Many other ramifications and variations are possible within the teachings of the various embodiments.

Thus the scope of the invention should be determined by the appended claims and their legal equivalents, and not by the examples given.

What is claimed is:

1. A method comprising:
transporting a container of beneficial gas by aircraft; and
releasing said beneficial gas from said container to the stratosphere at altitudes greater than five kilometers.

2. The method of claim 1, wherein said beneficial gas comprises oxygen.

3. The method of claim 1, wherein said beneficial gas comprises more than 20% oxygen.

4. The method of claim 1, wherein said beneficial gas comprises more than 50% oxygen.

5. The method of claim 1, wherein said beneficial gas comprises more than 90% oxygen.

6. The method of claim 1, wherein said beneficial gas comprises hydrogen.

7. The method of claim 1, wherein said aircraft comprises an airplane.

8. The method of claim 1, wherein said aircraft comprises a balloon.

9. The method of claim 1, further comprising:
releasing said beneficial gas from said container to said stratosphere at altitudes greater than seven kilometers.

10. The method of claim 1, further comprising:
releasing said beneficial gas from said container to said stratosphere at altitudes greater than ten kilometers.

11. The method of claim 1, further comprising:
determining a threshold ozone concentration level;
measuring the ozone concentration at said stratosphere; and
releasing said beneficial gas from said containers only when said measured ozone concentration is below said threshold ozone concentration level.

12. The method of claim 1, further comprising:
measuring the density of said stratosphere; and
releasing a quantity of said beneficial gas in proportion to said measured stratospheric density.

13. A method comprising:
transporting a container of beneficial gas by aircraft;
determining a threshold ozone concentration level;
measuring the ozone concentration of the stratosphere;
releasing said beneficial gas from said container to said stratosphere at altitudes greater than seven kilometers; and
releasing said beneficial gas from said containers only when said measured ozone concentration is below said threshold ozone concentration level.

14. The method of claim 13, wherein said beneficial gas comprises more than 50% oxygen.

15. The method of claim 13, wherein said beneficial gas comprises more than 90% oxygen.

16. The method of claim 13, wherein said aircraft comprises an airplane.

17. The method of claim 13, further comprising:
releasing said beneficial gas from said container to said stratosphere at altitudes greater than ten kilometers.

18. A method comprising:
transporting a container of beneficial gas by airplane;
determining a threshold ozone concentration level;
measuring the ozone concentration of the stratosphere;
measuring the density of said stratosphere;
releasing said beneficial gas from said containers only when said measured ozone concentration is below said threshold ozone concentration level;
releasing said beneficial gas from said container to said stratosphere at altitudes greater than seven kilometers; and
releasing a quantity of said beneficial gas in proportion to said measured stratospheric density.

19. The method of claim 18, wherein said beneficial gas comprises more than 90% oxygen.

20. The method of claim 18, further comprising:
releasing said beneficial gas from said container to said stratosphere at altitudes greater than ten kilometers.
